(19) United States
(12) Patent Application Publication
(10) Pub. No.: US 2005/0040261 A1
(43) Pub. Date: Feb. 24, 2005

(54) Nozzle for spraying of a surface

(76) Inventor: Hermann Lange, Metzingen (DE)

Correspondence Address: FLYNN THIEL BOUTELL & TANIS, P.C., 2026 RAMBLING ROAD, KALAMAZOO, MI, 49008-1699, US

(21) Appl. No.: 10/900,972

(22) Filed: Jul. 28, 2004

(30) Foreign Application Priority Data
Aug. 1, 2003 (EP) 03017433.8

(51) Int. Cl. B05B 7/06; B05B 1/26; B05B 1/30

(52) U.S. Cl. 239/569; 239/585.5; 239/461

(57) ABSTRACT

A nozzle for spraying of surfaces has a piston rod with an impact disk, which piston rod is arranged centrally in a feed channel, and which impact disk lies in one end position aligned in the surface to be sprayed and closes off an outlet opening of a flow channel, and lies in a second end position at a distance in front of this outlet opening so that the exiting liquid is deflected into an annular spray fan directed against the surface. The underside of the impact disk, which underside causes the deflection, has a recess on one half of the impact disk periphery, which recess is designed approximately trough-shaped and takes care that half of the annularly discharged spray jet forms a spray fan part, which is directed steeper against the surface than the other half of the spray fan. The spray fan can in this manner be limited to a smaller surface.

### FIELD OF THE INVENTION

The invention relates to a nozzle for spraying of a surface, comprising a housing having a feed channel with an outlet opening for the liquid to be sprayed, the outlet opening lying in the surface to be sprayed. The nozzle further comprises a piston rod that is centrally guided in the feed channel and has an impact disk that closes off the outlet opening in one end position, and lies at a distance in front of the outlet opening in a second end position, so that the exiting liquid is deflected into an annular spray jet directed against the surface.

### BACKGROUND OF THE INVENTION

Nozzles of the aforementioned type are known, for example, from DE 100 57 429 A1. They produce a rearwardly directed symmetrical spray fan forming a cone-shaped shell with a circular cross section. It has been found that with the use of such spray nozzles, excessive liquid is lost because, in part, areas are sprayed which do not need to be sprayed—as, for example, the edge areas of a surface.

The purpose of the present invention is to provide spray nozzles of the abovementioned type that provide an asymmetrical spray jet, with which it is possible to keep the sprayed surface smaller.

### SUMMARY OF THE INVENTION

To attain this purpose, the nozzle according to the invention includes a recess in the underside of the impact disk, facing the outlet opening, which extends parallel to the outer edge of the impact disk, and which extends approximately over half of the periphery of the impact disk. With this design it is possible for the water jet exiting through the annular gap around the piston rod to be deflected at a steeper angle back to the surface over that half of the periphery of the impact disk, so that an asymmetrical rearwardly directed annular spray fan is created, spraying a clearly smaller surface.

An embodiment of the invention provides a lock against rotation of the impact disk associated with the piston rod in order to make sure that the more narrow area of the spray fan points always into a specific direction.

The recess can in a further embodiment of the invention be trough-like and can follow a rounded area between the piston rod and the impact disk underside. The spray jet exiting along the rounded area in this region is therefore varyingly rearwardly deflected.

In a further embodiment of the invention, the inner edge of the recess can be arranged circularly about the axis of the piston rod, whereby a center section extends over an angle of approximately 90°. In outer areas adjacent to the center section, the inner edge of the recess can then extend outwardly approximately as straight lines from the center section, so that approximately half of the annularly exiting spray jet is deflected steeper downwardly and a smaller surface is sprayed in this manner.

The lock against rotation of the piston rod can in a further embodiment of the invention consist of a cam guided in a groove inside of and parallel to the axis of the housing, wherein the cam can be part of a guide plate for the piston rod, fixed against rotation to the piston rod.

### BRIEF DESCRIPTION OF THE DRAWINGS

The invention is illustrated in the drawings in connection with one exemplary embodiment and will be discussed hereinafter.

In the drawings:

FIG. 1 is a partial cross-sectional side view of a nozzle according to the invention;

FIG. 2 is a perspective illustration of the piston rod with an impact disk, which piston rod is inserted into the nozzle according to FIG. 1;

FIG. 3 is a view of the underside of the impact disk viewed in direction of the arrow III of FIG. 2;

FIG. 4 is a cross-sectional view of FIG. 3 in direction of the cross-sectional plane IV-IV;

FIG. 5 is a cross-sectional view of FIG. 3 in direction of the cross-sectional plane V-V; and

FIG. 6 illustrates the nozzle of FIG. 1 in the installed state and in operation, producing an asymmetrical rearwardly directed spray fan.

### DETAILED DESCRIPTION

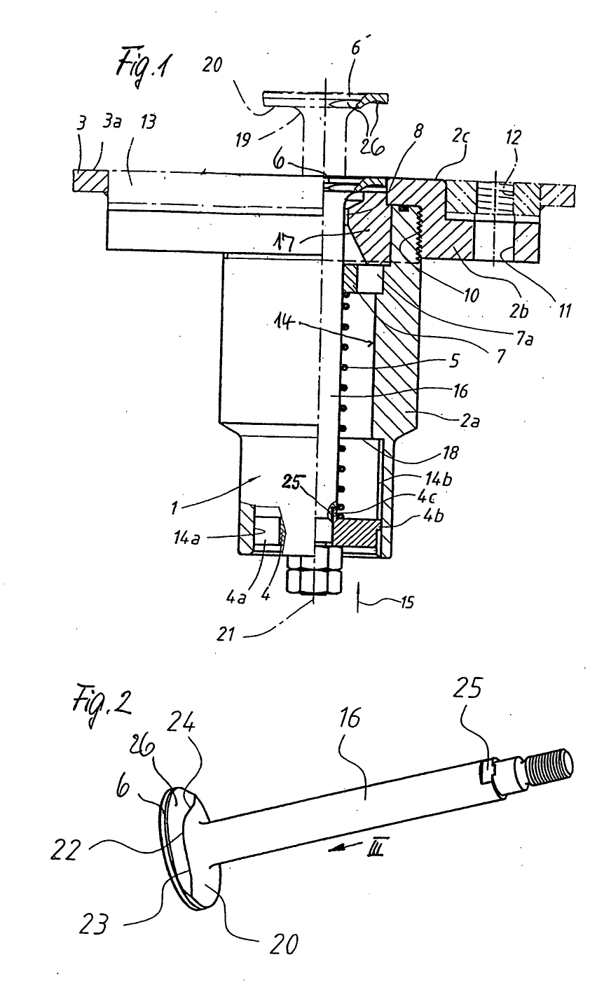

The nozzle 1 according to FIG. 1, which can also be identified as a deflector nozzle, consists of a housing 2a with a flange 2b, which is screwed through a thread 10 to said housing 2a. Flange 2b has openings 11 distributed about its periphery for receiving screws (not illustrated) to secure the flange 2b into corresponding receiving bores 12, which are, for example, provided on a ring 13 arranged in an opening of a wall 3, the outside of which is to be sprayed for the purpose of cooling.

The housing 2a has an offset cylindrical feed channel 14 for the liquid to be sprayed, the liquid being supplied (in a manner not illustrated in detail) from the connecting part of the housing 2a in direction of the arrow 15. A piston 4 is arranged in a section 14a of the feed channel 14, which section is larger in diameter, and which piston is fixedly mounted to the lower end of the piston rod 16. The piston 4 has through-openings 4a for the liquid to flow through and is used as a stop for a spiral coil spring 5 placed around the piston rod 16 with its other end on a guide plate 7 fixedly arranged in the housing 2a. Guide plate 7 is also provided with through-openings 7a for the liquid. The guide plate 7 is held in the housing 2a by an insert 17 that surrounds the piston rod 16, forming an annular gap 8. The piston rod 16 is provided with an impact disk 6 outside of the insert 17, which impact disk rests on the insert 17 in the illustrated position, and closes off an output opening ending at the surface 2c of the flange 2b. This surface 2c of the flange lies, as illustrated in FIG. 1, in a plane with the outer surface 3a of the wall 3, which in turn represents the surface to be sprayed for the purpose of cooling.

The nozzle operates as follows:

It can be recognized that when the liquid supply is released in direction of the arrow 15, the piston 4 is pressed upwardly against the action of the spring 5 until it hits the edge 18 of the cylindrical guide section 14a. The impact disk assumes in this position the position 6′, in which the piston rod 16, as illustrated by dash-dotted lines, is moved upwardly. The liquid therefore exists under pressure through the annular gap 8, is guided upwardly on the outer surfaces of the piston rod 16, and is deflected outwardly through the rounded area 19 adjacent to the surface 20 on the underside of the impact disk 6, 6′, which surface extends approximately perpendicularly with respect to the axis 21 of the piston rod 16. As illustrated in FIG. 6, the liquid is sprayed outwardly over a large surface in a flat spray fan 9, the reflection angle of which deviates only slightly from the horizontal. When several nozzles 1 are arranged on the surface 3a, these relatively large spray fans 9 can overlap so that a spraying covering the surface is possible.

When the liquid pressure is turned off, the piston 4 is returned by the spring 5 into the initial position illustrated in FIG. 1, in which initial position the impact disk is aligned with the surface 3a to be sprayed. The spring force is to be selected so that the applied water pressure can overcome this spring force.

FIG. 6 shows that the spray fan 9 is asymmetrical. The liquid fan is deflected significantly more steeply against the surface 3a on the right side so that the entire sprayed surface is smaller than if a symmetrical circular-conical spray fan 9, as in the state of the art, would have been produced.

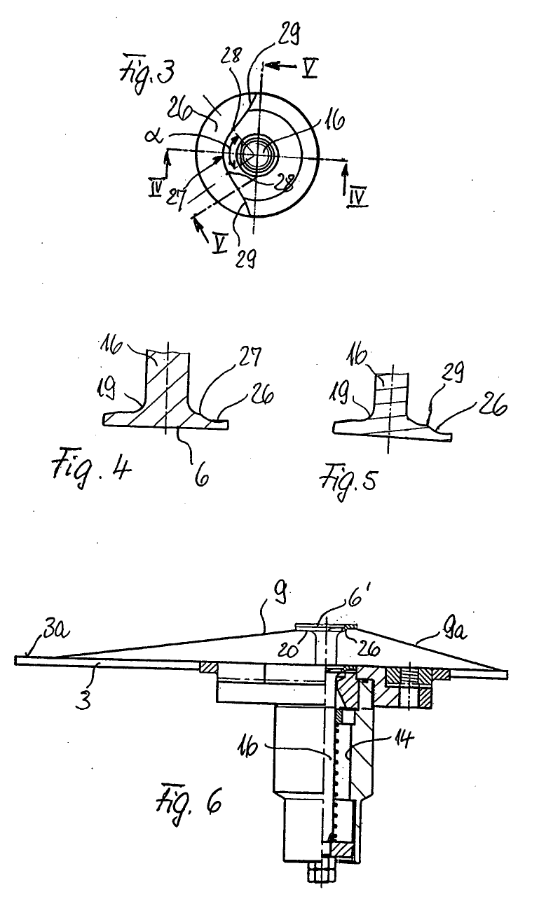

This form of the spray fan 9 is achieved by providing the impact disk 6 with a recess 26 on its underside, which recess extends parallel to the outer edge of the impact disk 6 and stretches approximately over half of the periphery of the impact disk. This recess 26 can be clearly recognized in FIGS. 2 and 3. It is designed approximately trough-shaped, as can be seen in FIGS. 4 and 5. It becomes clear that the recess 26 follows the rounded area 19 between piston rod 16 and impact disk 6 and has an inner edge 27 which extends in a center section between the points 28, circularly about the axis 21 of the piston rod 16. The inner edge then extends approximately rectilinearly or only slightly arched from the points 28 outwardly to the outer edge of the impact disk 6. These sections are identified with the reference numeral 29.

This design has the result, as shown in FIG. 6, that the spray fan 9 is directed with one leg 9a significantly steeper against the surface 3a to the side where the underside of the impact disk 6 has the recess 26. As a result, an asymmetrical rearwardly steered spray fan 9 is created and the entire sprayed surface is smaller than if the spray fan 9 would have the form of a cone-shaped shell with a circular base.

The just mentioned type of the asymmetrical spray fan with its alignment in a specific direction is guaranteed by a lock against rotation being associated with the piston rod 16. This exists in the exemplary embodiment by the piston 4 of the piston rod 16 engaging with an outwardly directed cam 4b an axially extending groove 14b of the flow-channel section 14a. The piston 4 in turn is held locked against rotation on the piston rod 16 by an inner projection 4c resting on a flattened area 25 of the piston rod 16.

One possibility of use for the nozzle according to the invention is, for example, the spraying of sidewalls of ships with the purpose to cool these and to then make them non-visible to infrared recognition. This new nozzle can thereby be used in edge areas of surfaces to be sprayed, beyond which a surface cooling is not desired or necessary.

As is the case with nozzles according to the state of the art, the new nozzle can be used for the spraying of surfaces when larger superstructures for holding and servicing of the nozzle are not desired outside of the surface.

1. A nozzle for spraying of a surface, comprising a housing which has a feed channel with an outlet opening for a liquid to be sprayed, which outlet opening lies in the surface to be sprayed, comprising a piston rod which is centrally guided in the feed channel and has an impact disk which closes off the outlet opening in one end position and lies at a distance in front of the outlet opening in a second end position so that liquid exiting the outlet opening is deflected into an annular spray jet directed against the surface, wherein the underside of the impact disk, which underside faces the outlet opening, has a recess which extends parallel to an outer edge of the impact disk and which extends approximately over half of a periphery of the impact disk.

2. The nozzle according to claim 1, wherein a lock against rotation is associated with the piston rod.

3. The nozzle according to claim 1, wherein the recess is designed trough-like and follows a rounded area between piston rod and impact disk.

4. The nozzle according to claim 3, wherein an inner edge of the recess extends in a center section circularly about an axis of the piston rod.

5. The nozzle according to claim 4, wherein the center section extends over an angle (α) of approximately 90°.

6. The nozzle according to claim 4, wherein outer areas of the edge, which outer areas are adjacent to the center section, extend approximately as straight lines.

7. The nozzle according to claim 2, wherein the lock against rotation consists of a cam guided in an axially extending groove of a section of the feed channel.

8. The nozzle according to claim 7, wherein the cam is part of a piston for the piston rod, the piston being connected locked against rotation to the piston rod.

9. The nozzle according to claim 8, wherein the piston is held with a projection locked against rotation on a flattened area of the piston rod.
